(19) United States
(12) Patent Application Publication
(10) Pub. No.: US 2009/0282882 A1
(43) Pub. Date: Nov. 19, 2009

(54) PROCESS FOR THE CONVERSION OF LIQUID WASTE BIOMASS INTO A FERTILIZER PRODUCT

(75) Inventors: Willem Arie Verhave, Utrecht (NL); Hette Verhave, Houten (NL); Gideon Verhave, Amsterdam (NL); Jitsche Verhave Jonkman, Utrecht (NL); Abigail Verhave, Utrecht (NL); Channa Jiska Verhave, Utrecht (NL); Raymon Frediansyah, Den Haag (NL); Marinus Cornelius Maria Van Loosdrecht, Den Haag (NL)

Correspondence Address: YOUNG & THOMPSON, 209 Madison Street, Suite 500, ALEXANDRIA, VA, 22314, US

(73) Assignee: Beesterzwaag Behkeer B.V., De Bilt (NL)

(21) Appl. No.: 12/280,560

(22) PCT Filed: Feb. 24, 2006
(86) PCT No.: PCT/NL2006/050037

§ 371 Date: Feb. 9, 2009

(51) Int. Cl. C05F 11/08

(52) U.S. Cl. 71/7

(57) ABSTRACT

A process for the treatment of liquid waste biomass, especially liquid manure compositions, wherein the biomass is converted to a fertilizer product. The process at least includes a nitrification step including a first biological conversion stage wherein ammonium is converted to nitrite using nitritifying bacteria in an aerated reactor, and a subsequent chemical oxidation stage wherein nitrite is converted to nitrate by heating the liquid waste biomass in an aerated reactor under acidic conditions. The process is particularly suitable for treating liquid manure, because of the high ammonium nitrogen contents thereof, which render the process essentially self-regulatory. In addition a process for the treatment of liquid waste biomass wherein organic matters are converted to energy sources, referred to as biogas and green cokes, and wherein nitrogen is fixed in a fertilizer product in the form of ammonium nitrate, is provided, the process including the present nitrification process.

### FIELD OF THE INVENTION

The present invention relates to the field of liquid waste biomass treatment. More in particular it relates to a process for the treatment of liquid waste biomass, wherein it is converted to a fertilizer product, which process at least includes a nitrification step wherein ammonium nitrogen from the waste product is converted into nitrate nitrogen. Highly efficient use of available energy and minimal emission of pollutants in discharge gases and water can be achieved by efficiently integrating said nitrification step and further processing steps in the process that is provided by further embodiments.

### BACKGROUND OF THE INVENTION

The term ‘liquid biomass’ as used herein refers to liquid products containing high amounts of solid organic materials as well as minerals. In particular, it relates to liquid manure products such as those obtained directly from animal farms, to (municipal) sewage water and waste streams of (food) industries, but also to waste water from composting installations for foliage of agriculture and horticulture, domestic waste, garden waste, etc.

Currently, most of such facilities use anaerobic digestion for treatment of e.g. animal wastes and wastewater. The primary reasons for using anaerobic digestion are simplicity and cost. Wastewater is simply discharged from the facility into an open lagoon where it undergoes natural anaerobic digestion. After retention in the lagoon system, wastewater is usually applied to (agricultural) land via spray irrigation. Noxious gases may be emitted from anaerobic lagoons comprising ammonia, methane and hydrogen sulphide.

The time required for digestion of the organic wastes is relatively long, from weeks to months. Often the reduction of organics and nutrients within an anaerobic lagoon is minimal. The disposal, e.g. by spray irrigation in agriculture, of waste treated in this way therefore often results in high quantities of ammonium nitrogen, phosphorus, solids, bacteria etc. being applied to the land. These nutrients readily build up high residual concentrations in the soil, leach directly into the groundwater or run-off into surface waters. Such increases in nutrient and organic matter content of lakes, streams and other water bodies contribute to excessive algae and aquatic plant growth. This growth has a high oxygen demand resulting in gradual depletion of the water's oxygen supply. This algae and plant bloom adversely affects fish and other aquatic life and has a negative impact on the beneficial use of water resources for drinking or recreation. If oxygen concentrations fall below a critical level, fish and other aquatic species die in massive numbers.

Since untreated organic waste, although it does have nutritional value for plants, can not be used directly as fertilizer due to the aforementioned problems, the alternative use of synthetic fertilizers is often adopted for increasing crop yield. Obviously the use of synthetic fertilizers neglects the problem of organic waste disposal. Moreover, the manufacture of synthetic fertilizers requires considerable energy consumption, involves polluting processing steps and produces additional waste products.

The problems inherent to organic waste production and subsequent treatment require economical processes, which avoid the afore-mentioned environmental problems. The efficiency of these processes is considerably enhanced when, in addition to providing a practical disposal of organic waste, the processes convert the organic waste into useful products, such as energy sources and commercial fertilizer products. This conversion requires the recovery of the nitrogenous, sulphurous and/or phosphorous products in the waste and their conversion into a fertilizer that can slowly release the nutrients in a form that plants can absorb. Because of the diversity of variables that determine the economic, chemical, and environmental aspects of this conversion process, a variety of attempts to treat organic waste have been undertaken.

Document U.S. Pat. No. 6,409,788 discloses integrated waste treatment and fertilizer and feed supplement production methods suitable for treating organic waste. The methods provide reduction or elimination of emissions of acrid and greenhouse gases; effluents that meet discharge standards and that can be used in wetland and irrigation projects, organic based granular slow release NPK fertilizer, methane rich biogas recovery for subsequent use for heating, power generation and feed supplement for cattle. The invention according to U.S. Pat. No. 6,409,788 includes the steps of a) obtaining organic waste, b) introducing the organic waste into a reactor clarifier to precipitate settable and non-settable material by mixing it with substances that include a flocculant, a phosphate precipitating agent, a base and optionally an ammonium retaining agent, thus producing a precipitate and a liquid, c) separating the precipitate from the liquid and d) drying the precipitate. During said process biogas is recovered. Ammonia is captured from the waste by precipitation and/or adsorption with one or more of the following agents: an ammonia retaining agent, such as a suitable natural or synthetic zeolite, a precipitating agent, such as magnesium chloride or a suitable brine, a densifier, such as clay, fly ash, bentonite, crushed limestone, zeolite, perlite and mixtures thereof, and a pH control agent, such as lime. It is furthermore mentioned that ammonia that has not been captured by incorporation into a salt or retained by a zeolite (or other retaining agent), which is released from the liquid at any stage is converted to ammonium sulphate in a scrubber, containing an aqueous solution of sulphuric acid.

WO 2004/056722 describes a method and a device for treating and upgrading raw manure. The method comprise steps which consisting in promoting agglomeration of solid constituents of the manure and precipitating the agglomerated particles using a sedimentation agent. The sedimentation agent used is based on natural stone powder and/or industrial derivatives. After sedimentation of the agglomerated particles the solid phase and the liquid phase are separated, e.g. by decantation. The solid phase is further processed to a solid fertilizer product. The liquid phase is concentrated using e.g. ultra filtration and/or reverse osmosis filtration yielding a liquid fertilizer product and water corresponding to environmental standards and capable of being released into the environment or readily recycled.

U.S. Pat. No. 5,656,059 discloses a method for processing a liquid nitrogen-rich organic waste product, in particular a manure product, to an aqueous fertilizer solution using a biological conversion process including at least a nitrification step wherein nitrifiable ammonium nitrogen is converted to nitrate nitrogen using nitrifying bacteria, and optionally a denitrification process. During the nitrification step, it is essential that the pH of the solution is kept at a value which enables nitrifying bacteria of both the genera Nitrosomonas and Nitrobacter to be sufficiently active.

The present inventors have found that on an industrial scale the conversion of ammonium to nitrate in a biological nitrification process according to the prior art is not particularly attractive from an economical point of view. During the nitrification process the conditions will have to be carefully controlled in order for the nitrifying bacteria to be able to grow and effectively convert ammonium into nitrate. This was found to be especially so, when liquid manure products are treated, such as those obtained directly from animal farms, which contain ammonium nitrogen in high amounts.

Thus, there is still a need for a process for treating liquid waste biomass, especially liquid manure, comprising a nitrification step wherein ammonium is nitrified to yield a useful fertilizer product comprising nitrogen in the form of ammonium and nitrate, which process can suitably be carried out on an industrial scale in an efficient and cost-effective manner. It is the objective of the present invention to provide such a process.

It may furthermore be desirable to provide a complete process for treatment of liquid waste biomass, wherein organic matters are converted to energy sources known as biogas and green cokes and wherein the nitrogen is fixed in a fertilizer product in the form of ammonium and nitrate, which process can suitably be carried out on an industrial scale.

### SUMMARY OF THE INVENTION

The present inventors have, as a result of extensive research and experimentation, found that the above mentioned objective can be realized using a nitrification process wherein ammonium is converted to nitrate, said nitrification process comprising a first biological conversion stage wherein ammonium is converted to nitrite, using nitritifying bacteria, and a subsequent chemical conversion stage wherein nitrite is converted to nitrate by chemical oxidation.

The process was found to be particularly suitable for treating liquid manure, because of the high ammonium nitrogen contents thereof, which render the process essentially self-regulatory, i.e. as a result of high concentrations of ammonia and nitrite and/or a decrease in pH during the process, the biological conversion will result in only a part of the ammonium, more particularly up to 50% of the ammonium, being converted to nitrite, yielding a solution rich in ammonium and nitrite, without the need of taking any measures to control or adjust the pH during normal operation. The solution so obtained is conveniently converted into a solution rich in ammonium and nitrate in the subsequent chemical oxidation stage, yielding a useful fertilizer product.

The present inventors have furthermore developed a process for the treatment of liquid waste biomass wherein organic matters are converted to energy sources biogas and green cokes and wherein the nitrogen is fixed in a fertilizer product in the form of ammonium and nitrate, comprising the present nitrification process. More particularly, the present inventors have combined and integrated the present nitrification process and various additional processing steps in such a way, that a method is provided which can suitably be carried out on an industrial scale, wherein energy spoilage is minimized; wherein higher percentages of minerals are recovered and captured in fertilizer products; and/or wherein higher percentages of organic matters are made available for energy generation.

### BRIEF DESCRIPTION OF THE DRAWINGS

FIG. 1 shows results of a biological nitritification process according to the present invention, in the form of a graph wherein nitrogen contents in the influent and in the reactor (effluent) are plotted against time.

FIG. 2 shows results of a chemical oxidation process according to the present invention in the form of a graph wherein nitrogen contents of the treated liquid are plotted against time.

FIG. 3 shows a flow chart of the present process for the treatment of liquid waste biomass comprising conversion of organic matters to energy sources and wherein the nitrogen is fixed in a fertilizer product in the form of ammonium and nitrate, using the present nitrification process.

### DETAILED DESCRIPTION OF THE INVENTION

Thus, a first aspect of the present invention relates to a process for treating liquid waste biomass, comprising a nitrification process wherein ammonium is converted to nitrate, said nitrification process comprising a first biological conversion stage wherein ammonium is converted to nitrite using nitritifying bacteria in an aerated reactor, and a subsequent chemical oxidation stage wherein nitrite is converted to nitrate by heating the liquid waste biomass in an aerated reactor under acidic conditions.

The liquid waste biomass to be treated according to the present invention can be any type of organic waste product, such as summarized previously herein. However, the process is most suitably used for treating liquid waste comprising not more than 20 wt % of solid matter. Preferably the liquid waste has a solid matter content of not more than 15 wt %. Typical examples include manure from cattle breeding, residues from the industry and residues from the food industry. However, according to another embodiment organic waste biomass from other sources, such as domestic waste, foliage, or waste from horticulture or agriculture, i.e. organic waste biomass having higher solid matter contents can be treated according to the present process provided that they are liquefied and/or diluted prior to treatment, preferably such that solid matter content is not more than 15 wt %. It is furthermore particularly preferred that the liquid waste biomass is rich in ammonium nitrogen. Typically, the concentration of ammonium nitrogen (also referred to as NH₄⁺—N) in the liquid waste biomass according to the invention is at least 2 gram NH₄⁺—N/liter, more preferably at least 3 gram NH₄⁺—N/liter. In an even more preferred embodiment said ammonium nitrogen content may range from 4 to 15 gram NH₄⁺—N/liter, preferably from 5 to 10 gram NH₄⁺—N/liter. In an even more preferred embodiment, the liquid waste biomass is a liquid manure product, such as can be obtained directly from animal farms. In such products the NH₄⁺—N content typically ranges from 6 to 8 gram NH₄⁺—N/liter. The maximum concentration of ammonium in such liquid manure products is typically about 15 gram N—NH₄⁺ per liter.

The process according to the present invention optionally comprises one or more pretreatment processing steps selected from removal of coarse materials, e.g. using coarse screens, grinding the solid parts of the biomass to form a homogeneous liquid and/or removal of sand, for example using a sand removal (hydro)cyclone. If the liquid waste biomass is not treated shortly after collecting it, it is preferably stored in a covered tank, which is typically provided with mixers that homogenize the biomass. The air under the covering of said tanks can suitably be connected to the digester, such that no biogas is lost.

The liquid waste biomass is preferably fermented prior to the nitrification process in order to reduce the organic matter content of this biomass, in particular when the liquid waste biomass has a solid matter content higher than or equal to 5 wt %. Therefore, preferably, the present process comprises an anaerobic digestion step, wherein organic matters are partly converted to biogas under mesophilic or thermophilic conditions. Hence the conditions typically comprise temperatures of between 30-45° C., more preferably between 35-40° C., or between 40-70° C., more preferably between 50-60° C., respectively. According to another preferred embodiment a part of the digestion is performed under mesophilic conditions, i.e. at a temperature of between 35-40° C., and another part of the digestion is performed under thermophilic conditions, i.e. at a temperature of between 50-60° C. The digestion is performed in one or more reactors provided with a covering. Preferably the covering comprises a flexible membrane such that the height of the covering can vary, allowing different amounts of biogas to be stored under the covering. Although the digestion is anaerobic, a dose of air is injected under the covering, which converts the hydrogen sulphide in the biogas to sulphates. Precautions are taken to prevent the formation of an explosive gas mixture.

It is furthermore preferred that the digester is isolated to prevent loss of heat. The net time that the biomass remains in the fermentation reactor is preferably between 5 and 50 days, more preferably between 10 and 40 days. More in particular, under mesophilic conditions the net fermentation time is between 15 and 40 days and under thermophilic conditions the net fermentation time is between 10 and 35 days.

In a preferred embodiment the digestion comprises a first stage wherein the anaerobically digesting biomass is intensively mixed or stirred, such that the biomass is kept homogeneous, and subsequently a second stage wherein the anaerobically digesting biomass is only gently mixed or stirred. During the second stage, i.e. wherein the biomass is only gently mixed or stirred, the biomass in the reactor is allowed to separate into a gaseous phase, a liquid phase and a solid phase and, in addition, desulphurization bacteria may be allowed to grow on the liquid surface. Both stages can take place in one reactor separated in time or, alternatively, in two or more separate reactors. Most preferably the fermentation is a continuous process wherein the first stage is carried out in a series of intensively mixed or stirred reactors and the second stage is carried out in a reactor which is non-mixed or only gently mixed. In another preferred embodiment the digestion comprises conversion of hydrogen sulphide that is formed during the digestion to sulphate using sulphide oxidizing bacteria or a chemical conversion, such that the hydrogen sulphide concentration in the released biogas does not exceed 500 ppm. During the digestion process, hydrogen sulphide is formed, at least a part of which is converted to sulphates by sulphide oxidizing bacteria. Typically, these bacteria grow under the covering of the digesters, just above the surface or on the surface of the liquid biomass. The dose of air, which is injected under the covering as explained herein before, is sufficient for the sulphide oxidizing bacteria to function, grow and multiply. The sulphide oxidation process will ensure that the hydrogen sulphide concentration in the biogas does not exceed 500 ppm, so that it can suitably be used as fuel. During combustion of said biogas the sulphide is burned to sulphur dioxide. According to a preferred embodiment the digestion comprises a first stage and a second stage both of which comprise the biological sulphide oxidation process.

According to a particularly preferred embodiment of the present invention, biogas released from the biomass during the digestion and optionally during storage and pretreatment, is collected. According to this embodiment, the biogas is lead to a combined cycle power plant comprising gas engines and electricity generators converting the biogas into thermal energy and electrical power, which is typically comprised in hot water having a temperature of 85-95° C. and flue gas having a temperature within the range of 350-550° C. Optionally, a biogas treatment installation will dehumidify the biogas to increase the caloric value of the biogas prior to combustion. The electricity is used in the installation itself. The surplus of electricity is supplied to the electricity grid as so-called green electricity. The thermal energy that is created during this processing step in the form of hot flue gas is preferably utilized in other processing steps of the present process, as explained in more detail hereafter.

It is furthermore preferred that after the aforementioned digestion step, a thick fraction is separated from the digested liquid waste biomass. More particularly, part or all of the digested liquid waste biomass from the digester is fed through a mixing chamber to a decanter. In the decanter, a thick fraction, which is also referred to as the concentrate, is separated from the liquid waste biomass, which is then also referred to as the centrate. This separation step may be performed in any other convenient way commonly known in the art, including for example centrifugation, filtration, filter pressing, belt press and screw pressing.

In a particularly preferred embodiment the aforementioned thick fraction is dried in a conventional dryer such that a pellet, the so-called green cokes, is obtained. During this processing step the dry material content is increased from approximately 25-35 wt % to at least 85 wt %, even more preferably at least 88 wt %. According to a particularly preferred embodiment, the drying of the thick fraction comprises transferring the thermal energy of the flue gas obtained by combustion of the biogas, to the thick fraction by means of a conventional direct or indirect dryer apparatus in order to provide heat for evaporating part of the water or, preferably, via steam produced using the hot flue gas from the gas engines. Vapor from the drying process is preferably collected and condensed. According to a particularly preferred embodiment the condensate so obtained is lead to the nitrification reactors, which will be described in more detail hereafter.

The term ‘green cokes’ as used herein, refers to a granulated material comprising non-digested organic material and mineral salts that are precipitated during the digestion, such as phosphate and sulphate salts. Green cokes can suitably be used as a fuel in coal-fired power stations to generate so-called green electricity. Alternatively, it can be used in (biological) agriculture as a fertilizer product. According to the present process the liquid waste biomass, which may have been pretreated in accordance with any or all of the above described embodiments, is converted to a liquid fertilizer product by subjecting it to the nitrification process according to the present invention.

As mentioned herein before, a two stage nitrification process is provided by the invention, wherein the ammonium that is present in the liquid waste biomass is converted to nitrate.

Typically, in the present nitrification process, the ammonium rich liquid waste biomass is converted into a liquid fertilizer composition rich in both ammonium and nitrate. As will be explained hereafter said liquid fertilizer composition will comprise ammonium and nitrate in approximately equimolar amounts, i.e. in a molar ratio ranging from 1:1.2 to 1:0.8. The liquid fertilizer composition may therefore be referred to as an ‘ammonium nitrate rich liquid composition’ or the like, although, as will be clear to the skilled person, ammonium and nitrate will mainly be present in dissolved ionized form and the liquid will also contain other species of anions and cations, such as potassium and chloride.

As described herein before, a nitrification process is provided, wherein in a first stage ammonium is converted to nitrite in an aerobic biological reactor using nitritifying bacteria, preferably nitritifying bacteria of the genus Nitrosomonas and/or other nitroso bacteria, and wherein in a second stage ammonium nitrite is converted to ammonium nitrate by chemical oxidation comprising heating the liquid waste biomass in an aerated reactor at a pH of below 6.

According to a preferred embodiment the first stage of the nitrification process, also referred to herein as the biological conversion (stage) or the nitritification, is performed with the aid of bacteria of the Nitrosomonas strain, although other nitroso bacterial strains may also suitably be applied instead of or in addition to the Nitrosomonas bacteria. Suitable examples of nitroso bacteria genera include Nitrosococcus, Nitrosospira, Nitrosolobus, and Nitrosorobrio. The present nitritifying bacteria strains are autotrophic bacteria, which use bicarbonate as a carbon source. Typically, if the liquid waste biomass has been subjected to an aerobic digestion step as described herein before, the ammonium has bicarbonate as a counter ion. The ratio between ammonium and bicarbonate after said digestion will approximately be 1:1. The nitritifying activity of Nitrosomonas bacteria and the other nitroso strains is typically inhibited by both ammonia and nitrite. It is believed that the exact inhibitive components are free ammonia, i.e. dissolved NH₃, and free nitrous acid, dissolved HNO₂. The approximate concentrations for complete inhibition are typically 3 to 5 mg/l free nitrous acid and 150 to 200 mg/l free ammonia for the Nitrosomonas and other nitroso-strains. The degree of inhibition brought about by free ammonia increases when pH increases. The degree of inhibition brought about by free nitrous acid increases when pH decreases. It has furthermore been found that nitrifying bacteria of the genus Nitrobacter are far more sensitive for inhibition by ammonia and nitrite than the nitritifying Nitrosomonas and other nitroso-strains. Thus, especially when the present nitrification process is used to treat liquid manure compositions, which, as mentioned before, comprise high levels of (ammonium) nitrogen, the conversion rate of nitrite to nitrate is very low.

The conversion of ammonium to nitrite by nitritifying bacteria, according to the present invention, involves the following reactions:

2 NH₄⁺+1.5 O2→NH₄NO₂+H₂O+2 H⁺ (1)

2 HCO₃⁻+2 H⁺→2 H₂O+2 CO₂ (2)

Such that the overall reaction can be represented as follows:

2 NH₄⁺+2 HCO₃⁻+1.5 O₂→NH₄NO₂+3 H₂O+2 CO₂ (3)

Thus, typically, in the present biological conversion for each molecule of ammonium that is converted to nitrite two molecules of acid are formed (1), which are neutralized by the consumption of two molecules of bicarbonate (2). By removing CO₂ by aeration, the liquid mass is stripped of HCO₃⁻, lowering the buffering capacity of the liquid. As a consequence of this and of the fact that the ratio of ammonium and bicarbonate initially is approximately 1:1 as mentioned herein before, the pH of the liquid waste biomass will drop after approximately 50% of the ammonium has been converted to nitrite, because acid formed typically is not neutralized anymore. Since the nitritifying activity of the nitrosomonas bacteria and the other nitroso strains is inhibited by free nitrous acid at lower pH, conversion of ammonium to nitrite will stop when approximately 50% of ammonium has been converted, yielding an ammonium nitrite solution. Since, according to the present invention, the desired product of the first biological conversion stage is ammonium nitrite, the process can thus be considered as being essentially self-regulatory. Thus, it is possible to operate the present process without the need to control the pH of the liquid biomass while being nitritificated, i.e. without the need to measure and adjust the pH by addition of concentrated alkaline solutions, in contrast to the prior art nitrification processes wherein it is desired to remove essentially all ammonium-nitrogen. As mentioned, before, hardly any nitrate will have formed at this point during the biological conversion stage, in case the liquid waste biomass comprises high levels of ammonium nitrogen, e.g. in case a liquid manure is treated, as the nitrifying activity of Nitrobacter is almost entirely inhibited under such conditions.

According to the present invention it is preferred that the biological conversion is performed in a closed aerated biological reactor. The process is typically operated at a temperature of between 35-45° C., more preferably 35-40° C. The biological conversion from ammonium to nitrite is an exothermic reaction. The reactor typically needs to be cooled to control the temperature. The aeration preferably takes place by means of a bottom aeration system. The pH of the present liquid waste biomass is preferably between 6 and 7. Therefore, the pH of the liquid waste biomass may be adjusted with caustic or acid to control the exact ratio between ammonium and nitrite, although, as mentioned before, this is not normally necessary. Dosing acid will increase the ammonium concentration, while dosing caustic will increase the concentration of nitrite. Under normal operation conditions, typically no acid or caustic are dosed. Caustic if added is preferably selected from potassium hydroxide, calcium hydroxide, sodium hydroxide and lime, more preferably from potassium hydroxide and calcium hydroxide. Acids that may be added in accordance with the invention are preferably selected from nitric acid, sulphuric acid, carbon dioxide and hydrochloric acid, more preferably from nitric acid and sulphuric acid.

Under the aforementioned conditions it is preferred that the net time that the biomass remains in the reactor is between 1 and 10 days, preferably 4-7 days. This time, which may also be referred to as the net retention time, equals to reactor volume divided by the total flow rate of the liquid waste biomass, in case the present process is operated in a continuous way. Typically during the biological conversion the reactor comprises a mixture of sludge comprising mainly bacteria mass and the liquid ammonium (nitrite) comprising waste biomass. Preferably subsequent to the biological conversion stage the process comprises settling of the mixture from the reactor, e.g. using a Dortmund tank or a plate-type separator and subsequent separation of the sludge from the liquid waste biomass. According to a particularly preferred embodiment the sludge is mixed with liquid waste biomass as defined herein before, preferably during or after the digestion step.

According to this embodiment however, it is particularly preferred that the sludge retention time in the reactor, which represents the average time the sludge is retained in the reactor, is higher than the growth rate of the nitritifying bacteria. If the sludge retention time is lower than the growth rate of the nitritifying bacteria, the bacteria will typically be washed out, thus preventing the growth of these bacteria in the reactor. The growth rate of Nitrosomonas bacteria and the other nitroso-strains has been found to decrease if the ammonium nitrogen concentration of the liquid waste biomass to be treated increases. It has been determined that at concentrations of 6-7 grams ammonium nitrogen per liter, the sludge retention time resulting in stable growth should typically be at least 2 days, more preferably at least 4 days, most preferably at least 5 days. At increased ammonium concentrations the required sludge retention time increases. It will be within the skills of a trained professional to establish a suitable sludge retention time in any given circumstances.

According to another preferred embodiment a biological reactor is used wherein bacteria mass is attached on a carrier, such that said mass is retained in the biological reactor. Suitable examples include a membrane bioreactor, a moving bed biofilm reactor, a packed bed bioreactor, a trickling filter bioreactor or a fluidized bed reactor. Advantageously, these types of reactors are more efficient with regard to the conversion itself as well as with regard to the separation step of the bacteria mass from the ammonium nitrite rich liquid product, which separation step may be reduced in time and volume or omitted completely. In case a reactor comprising bacteria mass on a carrier is employed, a gradient of the components inhibiting Nitrobacter may be created in the reactor, such that biological conversion of nitrite to nitrate by said Nitrobacter may be allowed in certain areas of the reactor.

According to another particularly preferred embodiment the biological reactor is aerated using the ventilation air from the closed areas of the biomass plant.

The second stage of the nitrification process comprises conversion of nitrite to nitrate using chemical oxidation. This stage is also referred to herein as the chemical oxidation stage. The chemical oxidation typically is an acid catalysed process, as will be explained in more detail hereafter. The reaction is preferably performed by increasing the temperature of the liquid waste biomass after the first stage of the nitrification process, and contacting said biomass with oxygen. The reaction mechanism can be represented by the following 5 reaction formulas:

2 HNO₂←→NO+NO₂+H₂O (4)

NO+NO₂←→N₂O₃ (5)

2 NO₂+H₂O←→HNO₂+NO₃⁻+H⁺ (6)

N₂O₃+NH₃→N₂ +HNO₂+H₂O (7)

2 NO+O₂→2 NO₂ (8)

These five reactions occur simultaneously and by adjusting the pH and temperature the amounts and ratios of the end components can partly be influenced. Reaction (6) is the nitrate forming reaction. Reaction (7) is the reaction in which the ammonia is converted to nitrogen gas. Reaction (8) is the real oxidation step. Reaction (4) and (5) show the formation of the dissolved gasses NO and NO₂, which can be stripped by aeration.

During the chemical oxidation, the pH is typically reduced using an acid, preferably nitric acid or sulphuric acid. These acids, are however not consumed during the reactions, as can be seen in the reaction formulas, and may thus be regarded as a catalyst. During the chemical oxidation the pH is preferably below 6, more preferably between 3 and 5. The conversion rate increases with a decrease in pH. During the reaction, the temperature of the reaction mixture is typically between 30-50° C. Increasing the temperature will increase the overall reaction rate.

The oxygen required for the aforementioned reactions to occur can either be oxygen from the air or enriched oxygen.

It is particularly preferred that the aforementioned first biological conversion stage and the second chemical oxidation stage are performed in separate reactors, which will also be referred to herein as the biological nitrification reactor(s) and the chemical nitrification reactor(s), respectively. It is furthermore preferred that the present nitrification process comprises the step of clarification of the biologically converted liquid coming from the biological nitrification reactor, wherein the sludge is separated, prior to introducing it in the chemical nitrification reactor for the chemical oxidation stage. Typically a Dortmund or plate separator clarifier is used.

According to the present invention, it is preferred that during the nitrification process at least 70%, more preferably at least 80%, still more preferably at least 90%, most preferably at least 95%, of the ammonium initially present in the liquid waste biomass is converted to ammonium nitrate. Hence, it is preferred that during the biological conversion stage at least 75%, preferably at least 85%, still more preferably at least 95% of the ammonium is converted to ammonium nitrite. According to one embodiment nitrifying bacteria of the genus Nitrobacter may be present in the biological reactor, converting some of the nitrite to nitrate. However, as mentioned before the nitrifying activity of the Nitrobacter bacteria will be substantially inhibited and washed-out, especially when the liquid waste biomass to be treated has a high ammonium nitrogen content, e.g. in case liquid manure is treated, such that typically not more than 5% of the ammonium will be converted to nitrate during the first stage of the nitrification process, according to this embodiment.

The treated ammonium nitrate rich liquid that is obtained after the nitrification process can suitably be used as fertilizer and is therefore also referred to as the liquid fertilizer.

The liquid fertilizer may typically be concentrated subsequent to the nitrification process, e.g. using a vacuum evaporator, preferably a vacuum evaporator with a mechanical vapour recompression in the first effects. During concentration, the mineral content is typically increased from approximately 1.5-4.5 wt % to 20-45 wt %, preferably 25-40 wt %, of which between 7-14 wt % is nitrogen. According to a preferred embodiment of the invention, part or all of the heat used for concentrating the liquid fertilizer composition is coming directly or indirectly from the gas motor where thermal energy is generated by combustion of the biogas as described herein before. The liquid fertilizer product so obtained is a so-called ‘NPK fertilizer’, which abbreviation stands for nitrogen, phosphate and potassium fertilizer. The contents of nitrogen, phosphate and potassium in the liquid product obtained are in part determined by the contents of the waste biomass treated. However, according to the present process, an NPK fertilizer is obtained which is relatively rich in nitrogen. A typical NPK fertilizer product obtainable by the present invention comprises 30-40 wt % of total solids; 5-9 wt % of nitrogen (N); 1-2 wt % of phosphate (P); and 4.5-7 wt % of potassium (K).

The condensed water from the vacuum evaporator may contain ammonium, and will most probably not meet the requirements for discharge on surface water. However in the case that the water does not meet the discharge standards the water is led through a reversed osmosis installation or ion exchanger before being discharged via a water basin wherein, the water is cooled and/or provided with higher oxygen content, e.g. using a fountain.

According to another particularly preferred embodiment, excess heat from the biological conversion and/or from the concentration process of the liquid composition is recycled by using it for heating the digester, e.g. using conventional heat exchangers whereby the cooling water from the reactor and the vacuum evaporator is transferred to the digester.

A particularly preferred aspect of the present invention relates to a process for the treatment of liquid waste biomass wherein organic matters are converted to energy sources, referred to as biogas and green cokes, and wherein nitrogen is fixed in a fertilizer product in the form of ammonium and nitrate, said process comprising:

a) anaerobic digestion, wherein organic matters are partly converted to biogas at mesophilic and/or thermophilic conditions;
b) collecting the biogas released from the biomass before and/or during the anaerobic digestion subsequently leading it to a power plant and converting the biogas into electrical power and thermal energy, comprised in hot water having a temperature of 85-95° C. and flue gas having a temperature within the range of 350-550° C.;
c) separating a thick fraction from the digested liquid waste biomass obtained in step a);
d) drying said thick fraction in a dryer such that a pellet, the green cokes, is obtained with a solid content of at least 85%;
e) conversion of the liquid from step c) to a liquid fertilizer by subjecting it to a nitrification process as described herein before;
f) concentrating a fraction of the liquid fertilizer obtained in step e) such that an ammonium nitrate product with a solid content of at least 20% is obtained.

Steps a-f of this process, as well as their preferred embodiments are explained in more detail here above.

Another aspect of the invention relates to a system for carrying out the aforementioned process for the treatment of liquid waste biomass wherein organic matters are converted to energy sources, referred to as biogas and green cokes, and wherein nitrogen is fixed in a fertilizer product in the form of ammonium and nitrate, said system comprising a digestion reactor, suitable for performing the anaerobic digestion of the biomass as described herein before; a gas motor and generator suitable for converting biogas to electricity; a separator apparatus, suitable for separating a thick fraction from the digested liquid waste biomass, as described herein before; a dryer suitable for drying the aforementioned thick fraction, preferably using directly or indirectly the heat generated by the gas motor; a biological nitrification reactor as described herein before; a chemical nitrification reactor as described herein before; and an evaporator apparatus suitable for concentrating the liquid fertilizer product obtained during the nitrification process, as described herein before.

The invention will hereafter be further illustrated by means of the following examples, which are in no way intended to limit the scope of the invention.

### EXAMPLES

### Example 1

### Nitritification Process

In this example a 2 L continuous flow stirred tank reactor (CSTR) was employed. The influent for the reactor consisted of digested manure, having an ammonium content of 6400 g NH₄⁺—N/m³. The net retention time of the manure was 5 days. The reactor was operated at a temperature of 35° C. During 19 days of operation, the nitrogen contents of the effluent were measured once every 4 or 5 days.

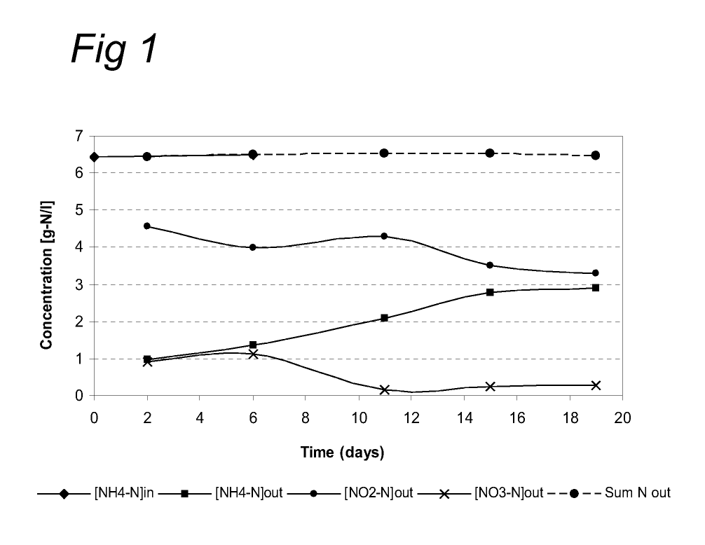

The results of this nitritification process are shown in FIG. 1, wherein the total effluent nitrogen content, the influent ammonium-nitrogen-content, the effluent ammonium-nitrogen content, the effluent nitrite-nitrogen content and the effluent nitrate-nitrogen content have been plotted against the total reaction time in days.

As can be seen in said figure, a steady state nitritification process had established after approximately 15 days. From that time on the [NH₄⁺]/[NO₂⁻] ratio in the effluent was about 0.9 and the conversion rate was approximately 700 g NH₄—N/m³_{reactor}/day. After day 2 no measures had been taken to control or adjust the pH of the nitritifying biomass in the reactor.

### Example 2

### Chemical Oxidation Process

In this example a 2 L batch reactor was employed, which was fed with nitritified manure from the effluent of the previous example containing 200 mM ammonium nitrite (NH₄NO₂). The reactor was operated at a temperature of 45° C. The liquid in the reactor was acidified to pH=4.0. The reactor was aerated with a constant flow of 1.5 l/min. of air. During 20 hours of operation, the nitrogen contents of the liquid in the reactor were measured.

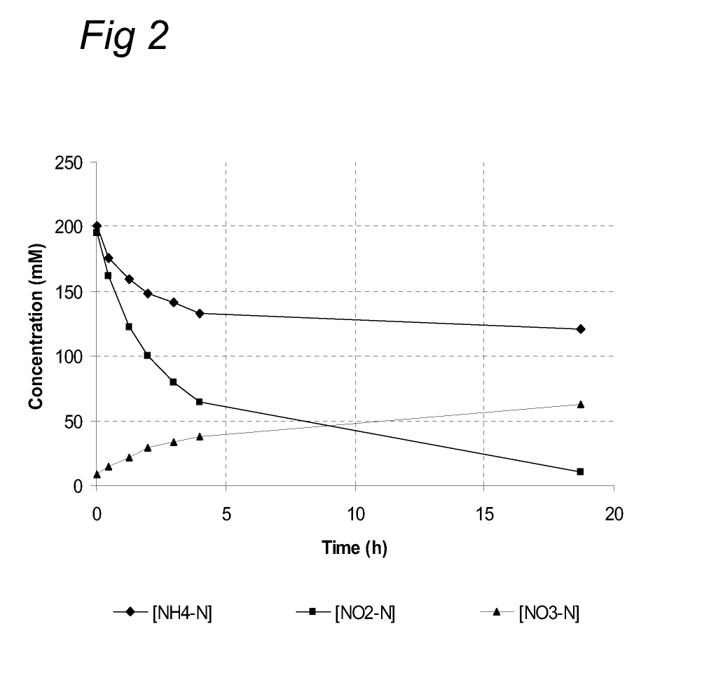

The results of this chemical oxidation process are shown in FIG. 2, wherein the ammonium-nitrogen-content, the nitrite-nitrogen content and the nitrate-nitrogen content have been plotted against the total reaction time in hours.

As can be seen in said figure ammonium nitrite was converted to ammonium nitrate. The main nitrogen loss was due to the formation of nitrogen gas (N₂) as described by the above described reaction (7). Some nitrogen was furthermore lost due to the volatilization of HNO₂ and NOₓ.

### Example 3

### Complete Waste Treatment Process

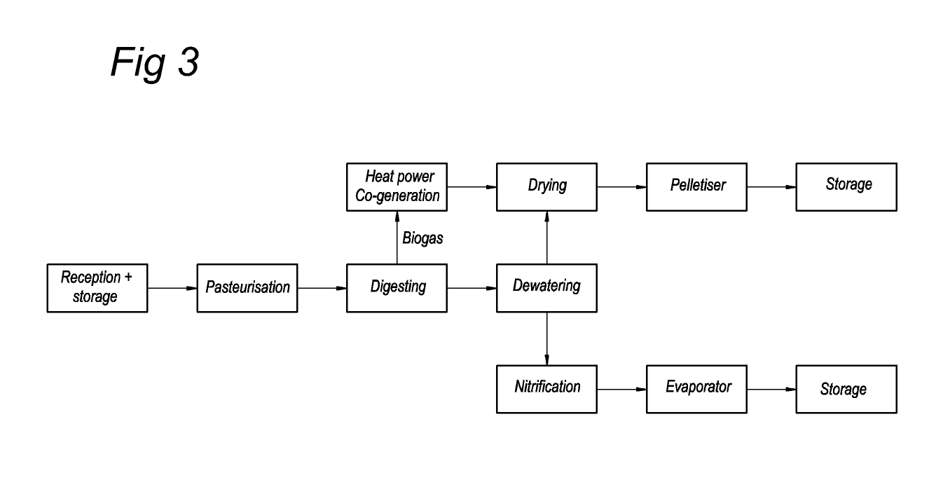

One complete exemplary process according to the present invention is described here with reference to the accompanying schematic flow chart shown in FIG. 3. The process starts with the collection of liquid and optionally solid waste biomass which is dumped a cellar. In the dumper cellar the biomass is mixed until the biomass can be pumped to storage tanks. The liquid biomass will be pumped via a stone catcher and grinder to the biomass storage tanks. The storage tanks contain pumps or mixers to mix the biomass or keep the biomass mixed. The storage tanks and the digesters will have a cover. Underneath this cover biogas will accumulate. The storage tanks are connected to a digester via a gas line to each other.

According to European legislation (1774/2002/EG) the biomass needs to be pasteurised. This is done by heating the biomass to 70° C. for a minimum of 1 hour for class 3 biomass.

To digest the biomass anaerobic bacteria are needed. These bacteria convert the biomass partly to biogas. The digestion takes place at temperatures of maximal 54° C.

The cover of the digester is a double PVC membrane. The inner membrane results in a variable biogas storage volume. The outer membrane protects the systems from weather conditions outside. The liquid in the digester is completely mixed. The digestate form the digester flows to the secondary digester, where the last part of the biomass is converted to biogas. The temperature in the secondary digester will be lower than the main digester. The cover will also be a double membrane. The secondary digester is not completely mixed, but mildly stirred, to ensure that desulphurisation bacteria will grow on the liquid surface. The bacteria will reduce the hydrogen sulphide to sulphate with oxygen. Oxygen is injected to the biogas underneath the inner membrane. The oxygen concentration needs to be below 4 vol %. This concentration is the lower explosion limit. The biogas is subjected to an additional biological desulphurisation step to ensure the lowest possible sulphide concentration in the biogas in a special tank, which is located between the digesters. The sulphide needs to be removed to increase the life time of the gasmotors.

The pressure of the biogas is increased with the compressors to a minimum of 200 mbar.

In emergency situations when the biogas buffer is completely filled, for instance at break down of the gasmotors, the excess biogas needs to be flared.

The HPC supplies heat and electricity out of the biogas. The heat is used in the hygienisation, dryer and evaporator. The heat from the off-gas from the gas engines is used to produce low pressure steam (7 bar, 165° C.), which is used to heat-up the dryer.

A steamboiler is used to produce additional heat from natural gas. The boiler has a dual fuel control to be able to burn both biogas and natural gas.

The digestate is separated in a centrate and concentrate by a decanter. The centrate (thin fraction) contains the biggest part of nitrogen components, while the concentrate (solid fraction) contains the biggest part of the phosphates.

The concentrate from the decanter is fed to a dryer. The dryer is heated by the steam produced from the heat exchanger in the off gas of the gasmotors.

The dried concentrate is pelletised and used as biofuel in coal or biomass fired power plant. The dryer is located in a separate room. The moisture from the dryer is condensed and used to produce hot water. The condensate is recycled to the conversion process. The non condensables are treated before they are emitted.

The main part of the nutrient in the centrate (thin fraction) will be ammonium. Ammonium is converted to nitrite in a biological conversion step. In a second step nitrite is converted to nitrate by addition of acid and air. Ammonium nitrate is the most used fertiliser product in the world. The liquid out of the conversion is called NPK.

Between the two steps of the conversion part the sludge is separated in a separator. The sludge is pumped to the digester.

The air form the conversion is treated in an absorption column. The air from the plant and the conversion is treated using a biofilter to reduce the emission of odorous components. The effluent of the conversion still contains considerable amounts of water. To concentrate the fertiliser and reduce the transport cost water is evaporated from the said effluent. This is done in an evaporator. The evaporator produces condensed water and NPK concentrate. The concentrated NPK is stored in a tank and is ready to be transported.

The condensed water form the evaporator is cooled to 30-40° C. and stored in a basin before it is discharged to surface water or the local sewer.

The heat of the process needs to be discharged via a cooling tower.

1. A process for treating liquid waste biomass having an ammonium nitrogen content within the range of 4-15 gram NH₄⁺—N/liter, the process comprising a nitrification process wherein ammonium is converted to nitrate, said nitrification process comprising a first biological conversion stage wherein ammonium is converted to nitrite using nitritifying bacteria in an aerated reactor, and a subsequent chemical oxidation stage wherein nitrite is converted to nitrate by heating the liquid waste biomass in an aerated reactor under acidic conditions.

2. Process according to claim 1, wherein liquid waste biomass has an ammonium nitrogen content within the range of 5-10 gram NH₄⁺—N/liter.

3. Process according to claim 1, wherein the liquid waste biomass is a liquid manure composition.

4. Process according to claim 1, wherein the nitritifying bacteria comprise bacteria of the genera Nitrosomonas, Nitrosococcus, Nitrosospira, Nitrosolobus, and/or Nitrosorobrio.

5. Process according to claim 1, wherein during the chemical oxidation stage, the pH of the liquid waste biomass is below 7 and the temperature is between 30 and 50° C.

6. Process according to claim 1, wherein the liquid waste biomass is subjected to an anaerobic digestion step prior to the nitrification process, wherein organic matters are partly converted to biogas under mesophilic or thermophilic conditions.

7. A process for the treatment of liquid waste biomass wherein organic matters are converted to energy sources and wherein nitrogen is fixed in a fertilizer product in the form of ammonium and nitrate, said process comprising:
a) anaerobic digestion, wherein organic matters are partly converted to biogas at mesophilic or thermophilic conditions;
b) collecting the biogas released from the biomass before and/or during the anaerobic digestion subsequently leading it to a power plant and converting the biogas into electrical power, and thermal energy, comprised in hot water and flue gas;
c) separating a thick fraction from the digested liquid waste biomass obtained in step a);
d) drying said thick fraction in a dryer such that a pellet, the green cokes, is obtained with a solid content of at least 85%;
e) conversion of the liquid from step c) to a liquid fertilizer composition by subjecting it to a nitrification process as defined in claim 1;
f) concentrating a fraction of the liquid fertilizer obtained in step f) such that a product with a solid content of at least 20% is obtained.

8. The process according to claim 7, wherein step a) comprises a first stage wherein the digesting biomass is intensively mixed or stirred and subsequently a second stage wherein the digesting biomass is only gently mixed or stirred or not mixed at all.

9. The process according to claim 7, wherein step a) comprises conversion of hydrogen sulphide that is formed during the digestion to sulphate using sulphur oxidizing bacteria or a chemical conversion, such that the hydrogen sulphide concentration in the released biogas does not exceed 500 ppm;

10. The process according to claim 7, wherein step d) comprises transferring the thermal energy of the flue gas produced in step b) to the thick fraction by means of a direct dryer in order to promote the drying of the thick fraction before subjecting the flue gas to step f).

11. A system for carrying out the process for the treatment of liquid waste biomass wherein organic matters are converted to energy sources and wherein nitrogen is fixed in a fertilizer product in the form of ammonium and nitrate, as defined in claim 6, said system comprising a digestion reactor, suitable for performing the anaerobic digestion of the biomass; a gas motor and generator suitable for converting biogas to electricity; a separator apparatus, suitable for separating a thick fraction from the digested liquid waste biomass; a dryer suitable for drying the aforementioned thick fraction using directly or indirectly the heat generated by the gas motor; a biological nitrification reactor; a chemical nitrification reactor; and an evaporator apparatus suitable for concentrating the liquid fertilizer product obtained during the nitrification process.

12. Process according to claim 2, wherein the liquid waste biomass is a liquid manure composition.

13. The process according to claim 8, wherein step a) comprises conversion of hydrogen sulphide that is formed during the digestion to sulphate using sulphur oxidizing bacteria or a chemical conversion, such that the hydrogen sulphide concentration in the released biogas does not exceed 500 ppm;

14. The process according to claim 8, wherein step d) comprises transferring the thermal energy of the flue gas produced in step b) to the thick fraction by means of a direct dryer in order to promote the drying of the thick fraction before subjecting the flue gas to step f).

15. The process according to claim 9, wherein step d) comprises transferring the thermal energy of the flue gas produced in step b) to the thick fraction by means of a direct dryer in order to promote the drying of the thick fraction before subjecting the flue gas to step f).
